(19) United States
(12) Patent Application Publication
(10) Pub. No.: US 2011/0002817 A1
(43) Pub. Date: Jan. 6, 2011

(54) FUEL COMPOSITION ON H2O2-BASIS, METHOD FOR PRODUCING SUCH A FUEL COMPOSITION AND DEVICES FOR ITS UTILIZATION

(76) Inventor: Peter Jeney, Zug (CH)

Correspondence Address: MCCORMICK, PAULDING & HUBER LLP, CITY PLACE II, 185 ASYLUM STREET, HARTFORD, CT, 06103, US

(21) Appl. No.: 12/812,054

(22) PCT Filed: Jan. 9, 2008
(86) PCT No.: PCT/EP08/50193

§ 371 Date: Sep. 9, 2010

(51) Int. Cl. C10L 1/18; B01J 19/00

(52) U.S. Cl. 422/198; 44/322

(57) ABSTRACT

Described is a colloidal fluid composition, comprising H₂O₂, hydrocarbon(s) and at least one additive, in particular at least a colloid fluid stabilizing agent. The composition can be made using aqueous H₂O₂ solutions comprising e.g. 30 to 50% H₂O₂ and is suitable as fuel for different kinds of engines. This colloidal fluid composition can be processed and transformed by a device (100).

The invention relates to engine fuel compositions and rocket fuel compositions. The invention also relates to special systems and devices using these fuel compositions. The invention also relates a method for producing such a fuel and a method for using such a fuel.

### BACKGROUND ART

H₂O₂ in concentration of 85% is a recognized rocket propellant. It is known that the fuel decomposes in a chamber under high pressure and temperature in the presence of catalysts, whereby the fuel is converted to H₂O in the form of steam and oxygen, and the gas stream exits the chamber at high speed. This process can be compared to other well-known rocket-propelled processes.

Normally, the catalyst consists of precious or rare metals such as silver, platinum, palladium or related alloys, which trigger the required decomposition process when the concentrated H₂O₂ flows through it. For aerospace applications in the past, inexpensive catalysts made out of other materials such as sodium or potassium permanganate have been used to activate the decomposition of the concentrated H₂O₂. All these technologies, however, have the significant disadvantage that the catalysts have a limited shelf-life and the systems only work with highly concentrated H₂O₂. Another serious shortcoming is the relatively low energy content of concentrated H₂O₂, as well as the eminent dangers referring to handling, storage and transport of this product. Furthermore, another crucial factor for aerospace applications is the space requirement for placing the catalyst.

There is a trend towards a so-called hydrogen economy where cars and other systems will be driven by hydrogen. But the handling of hydrogen has a number of known disadvantages. Hydrogen peroxide (H₂O₂) is currently not being considered as fuel since it is considered to be difficult to handle, dangerous and expensive to produce.

The present invention seeks to provide a new fuel system or composition which eliminates the above disadvantages and simultaneously creates a cost-effective and environmentally friendly fuel system or composition that is easy to store and employ.

It is another object of the present invention to provide a new fuel system or composition that can be produced and stored easily.

It is another object of the present invention to provide a systems and device which use the respective fuel system or composition in order to generate power and/or to turn the energy of said fuel system or composition into mechanical or electrical energy.

Now, in order to implement these and still further objects of the invention, which will become more readily apparent as the description proceeds, the fuel is manifested by the features that it is a colloidal fluid composition comprising a mixture of H₂O₂ (calculated for 100% H₂O₂) and hydrocarbon. Said H₂O₂:hydrocarbon mixture has a ratio of from about 31%:about 7% to about 47%:about 6%, preferably from 31.3% H₂O₂ and 6.9% hydrocarbon to 46.9% H₂O₂ and 6.3% hydrocarbon. Furthermore, the new fuel system or composition comprises at least one stabilizer additive.

The fuel system or composition can be made by mixing 93 to 94.5% by weight of aqueous H₂O₂ having a concentration of 30 to 60% by weight, in particular 30 to 50% by weight, with 7 to 5.5% by weight hydrocarbon to give a total of 100% by weight.

To this fuel system or composition at least one of the following stabilizing additives may be added (these additives are optional):

anti-knock additives

anti-oxidant additives

static dissipater additives

icing inhibitor additives

corrosion inhibitor additives

power boosting additives.

The inventive fuel system or composition is a colloidal fluid composition or colloidal dispersion with a high degree of homogeneity (i.e. a nearly homogenous mixture). The inventive fuel system or composition comprises at least two phases: a hydrocarbon phase and an H₂O₂ phase. Preferably, the hydrocarbon phase is distributed evenly throughout the H₂O₂ phase so that a homogeneous mixture is provided.

Preferably, the hydrocarbon content or portion of the inventive fuel system or composition is a hydrocarbon mixture being primarily composed of aromatic hydrocarbons, olefinic hydrocarbons, also known as alkene hydrocarbons, and saturated hydrocarbons, i.e. alkanes, also known as paraffinic hydrocarbons, and/or cycloalkanes.

Very well suited are hydrocarbon mixtures comprising one or more of the following:

Kerosene (e.g. JP-6 kerosene, or Jet-A or Jet-A1 kerosene)

gasoline

diesel

paraffin oil

N-hexane (preferably mixed or combined with ammonium nitrate)

Methanol

Ethanol

Azethon (preferably mixed or combined with ammonium acid)

Preferably, the hydrocarbon amount is selected so that the stoichiometric amount of oxygen provided by the H₂O₂ is approximately twice the stoichiometric amount of carbon provided by the hydrocarbon. This ensures that the respective oxygen is used for producing CO₂ as output gas.

An inventive fuel system or composition with the above described ratio of aqueous H₂O₂ and hydrocarbons can be brought into a stabilized dispersion by the addition of one or more further additives as mentioned above. An essential additive for stabilizing the dispersion is the stabilizing additive that in general is one or more alcohols, in particular ethanol and/or propanol (n-propanol and/or isopropanol). The necessary amount can easily be determined by simple storage experiments. In general it is in the range of 1.5 to 15%, whereby for ethanol preferably at least 5% vol. are present, while in the case of isopropanol 1.5% vol. are sufficient. The minimally necessary and/or the optimal amount may vary dependent on other additives present.

An obvious benefit of this invention is that the inventive fuel system or composition, in spite of the high water content, surprisingly has very a high energy value and therewith represents a significant advantage for all moving and flying objects where endurance and long range is desired and where the ratio between fuel and total weight is of importance.

Furthermore, this new fuel system or composition is very safe to handle and—due to its high water content—can not be ignited with an open flame.

Another advantage of the present invention is that the fuel system or composition does not need a secondary injection for another fuel component, since the fuel system or composition as such is already kind of a bi-fuel. This bi-fuel, however, carries all reagents in itself and the reagents are stabilized.

While the fuel system or composition of the present invention, due to the high energy content, might allow the design of a smaller engines or systems, it can also be used with known engines or systems.

According to the present invention the aims are achieved by providing a liquid fuel system or composition, a method for its production as well as systems or devices utilizing the respective fuel system or composition.

The fuel system or composition of the present invention is characterized in that it is a colloidal fluid composition comprising a H₂O₂ (calculated for 100% H₂O₂):hydrocarbon mixture ratio of from about 31%:about 7% to about 47%:about 6%, preferably from a minimal H₂O₂ content of 31.3% to 6.9% hydrocarbon mixture to a maximal H₂O₂ content of 46.9% to 6.3% hydrocarbon mixture (all % are % by weight) and at least one additive, in particular at least a stabilizing additive.

Such a mixture can be produced by using a low concentration solution of aqueous H₂O₂, namely a concentration of 30-50% by weight, although higher concentrations can also be used. Besides of this aqueous H₂O₂, the liquid fuel system or composition comprises a certain amount of hydrocarbons and one or more additives to stabilize the colloidal fluid.

The fuel composition or system can be made by mixing 93 to 94.5% by weight of aqueous H₂O₂ having a concentration of 30 to 60% by weight, in particular 30 to 50% by weight, with 7 to 5.5% by weight hydrocarbon mixture to give a total of 100% by weight. To this mixture at least one stabilizer additive is added. Optionally, the following stabilizing additives may be added:

anti-knock additives

anti-oxidant additives

static dissipater additives

icing inhibitor additives

corrosion inhibitor additives

power boosting additives.

The hydrocarbon mixture preferably has the following composition (in % by weight)

approx. 10-20% aromatic hydrocarbons,

approx. 0.5-1.5% olefinic hydrocarbons, 30 also known as alkene hydrocarbons,

approx. 80-85% saturated hydrocarbons, i.e. alkanes, also known as paraffinic hydrocarbons, and/or cycloalkanes.

The aromatic hydrocarbons are primarily selected from benzene derivetives. They preferably are selected from the group consisting of toluene, xylene, ethyl benzene, and mixtures of two or more thereof. Much preferred, the aromatic component comprises toluene and xylene and ethyl benzene whereby in a three component mixture the minimal amount of each is 5%, preferably 10%, wherein the three xylenen isomers are considered as one component.

Preferred olefinic hydrocarbons are C3 to C15 hydrocarbons with 1 to 3 double bonds. They can be used in pure form or in mixture with one or more compounds falling under the above definition. Suitable olefinic hydrocarbons or mixtures of olefinic hydrocarbons are liquid at room temperature.

The aliphatic hydrocarbons are selected from liquid hydrocarbons and liquid hydrocarbon mixtures, in particular from linear and branched C4 to C15 hydrocarbons, and/or from cycloalophatic hydrocarbons, in particular from alkyl substituted cyclopentanes and alkyl substituted cyclohexanes, in particular from alkyl substituted cyclopentane or alkyl substituted cyclohexane having a total carbon content of 15 C-atoms, preferably 13 C-atoms. Suitable aliphatic or cycloaliphatic hydrocarbons or mixtures of such hydrocarbons are liquid at room temperature.

Further to the above basic elements, additives are required to obtain a colloidal fluid with H₂O₂, water and the hydrocarbon content and—if present—a critical mixture of at least one organic nitrogen compound or a nitrated aromatic compound. In general, the additives are added in the following amounts:

Anti-knock additives 2-5.7 mg/l

Antioxidant additives 10-15 mg/l

Static dissipater additives 0.6-4.5% vol.

Icing inhibitors about 0.10-0.15 mg/l

Corrosion inhibitors about 0.05-0.20 mg/l

Stabilizer additives 1.5-15% vol.

Power boosting additives 0.02-2.00% vol.

The amount of additives added is referred to the aqueous H₂O₂ and hydrocarbon comprising fuel system or composition (basic composition), i.e. mg/l basic composition and % by volume with the basic composition being 100%.

Examples for anti-knock additives are additives based on propylene alcohol and/or ketones and/or aldehydes (see also stabilizer additives).

Examples for antioxidant additives are phenols or organic sulphides or polysulphides, dithiocarbamates, phosphates and phosphonates. The antioxidant additives are added to prevent the formation of gum deposits and to prevent other oxidation problems.

Examples for static dissipater additives are nitroso compounds based. They are not required but added for security reasons to reduce the creation of electricity which may be generated by the movement of the fuel through modern, high-flow-rate fuel transfer lines.

Examples for icing inhibitors are isopropanol and isopropylen and mixtures thereof that are e.g. used among others to prevent the formation of ice crystals. These additives are also helpful to create—and even more important to stabilize—the colloidal fluid between hydrocarbons and the aqueous H₂O₂ (see also stabilizer additives).

Examples for corrosion inhibitors are phenol derivatives such as dibutylmethylphenol (BHT) and butylhydroxyanisol (BHA). The corrosion inhibitor additives serve the protection of ferrous metals in fuel handling systems.

Examples for stabilizer additives are liquid alcohols such as ethanol or propanol, whereby in the case of ethanol preferably at least 5% vol. are present, while in the case of isopropanol 1.5% vol. are sufficient. Glycol is also well suited. Other stabilizer additives that are very well suited are surface-active agents having a hydrophobic and hydrophilic group, preferably a tenside. The surface-active agents act as friction-reducing surfactant and thus stabilize the fuel composition or system. The stabilizer additives are added to stably keep the fuel system or composition colloidal. The alcohols can be used in mixture of two or more thereof, whereby the amount of long chain alcohols must be limited to avoid phase separation (see also anti-knock Additives and icing inhibitors).

Examples for power boosting additives are nitrated aromatics, e.g. trinitrobenzene and related compounds or TNT (Trinitrotoluene). The addition of power boosting additives is optional. A power boosting additives is characterized by the fact that it is able to provide radicals.

As can be seen from the above list, some of the compounds may have different functions such as e.g. isopropanol that can act as stabilizer additive and icing inhibitor additive. In such cases, the two amounts may be additive. But in most cases it is sufficient to add a smaller amounts if one and the same additive performs two functions

With extensive tests mixing relations between hydrocarbons and 30-60%, preferably 30 to 50% concentrated H₂O₂ could be found that provide an easy to store, non-explosive, colloidal fluid which, according to this invention, has an energy value of approximately 3 times the normally used high concentrated 85% H₂O₂ mono-fuel. These tests showed that the mixture relation between H₂O₂(calculated for 100% H₂O₂) is from 31% H₂O₂ to 7% hydrocarbon mixture:47% H₂O₂ to 6% hydrocarbon mixture, preferably from 31.3% H₂O₂ to 6.9% hydrocarbon mixture:46.9% H₂O₂ to 6.3% hydrocarbon mixture. If 30-50% concentrated H₂O₂ is used, the mixing ratio of said H₂O₂ preferably should be in relation of 93.1% H₂O₂ to 6.9% hydrocarbon mixture, up to 93.7% H₂O₂ to 6.3% hydrocarbon mixture respectively whereas the hydrocarbon whereas the hydrocarbon mixture preferably is the hydrocarbon mixture described in this invention.

A fuel system or composition in this ratio can be brought into a stabilized dispersion by the addition of one or more further additives as mentioned above.

An essential additive for stabilizing the dispersion is the stabilizing additive.

An obvious benefit of this invention is that the inventive mixture with a substantially higher energy value represents significant advantages for all flying and moving objects where endurance and long range is desired and where the ratio between fuel and total weight is of importance. Furthermore, this new fuel system or composition is very safe to handle and can not be ignited with an open flame.

It is a further advantage that the new fuel system or composition does not react or explode in an open space. It requires a certain well controlled pressure to enable a reaction at all.

Another advantage of the present invention is that the fuel does not need a secondary injection for another fuel component, as is the case with conventional bi-fuels.

In order to improve ignition, it might be advantageous to pre-treat the fuel with a pre-dissociation enhancing substance. Such pre-dissociation enhancing substance could be a catalyst (e.g. a mixture of CoO and NgO).

The present fuel system or composition enables the construction of small and simple engines, rockets, machines and the like, where the handling of the fuel is simple and easy and not dangerous in any way.

While there are shown and described presently preferred embodiments of the invention, it is to be distinctly understood that the invention is not limited thereto. The aspects and features of the different embodiment disclosed may be combined with each other.

### BRIEF DESCRIPTION OF THE DRAWINGS

For a more complete description of the present invention and for further objects and advantages thereof, reference is made to the following description, taken in conjunction with the accompanying drawings, which show:

FIG. 1 a schematic diagram of a device in accordance with the present invention;

FIG. 2 a cross-section of the main part of one possible engine in accordance with the present invention;

FIG. 3 a cross-section of one possible element of an engine in accordance with the present invention.

### DETAILED DESCRIPTION

The present invention concerns different kinds of engines. The expression engine is herein used as a synonym for the following: motors, generators, actuators, reactors, power units, drives, pumps, compressors, turbines, rockets. Such an engine is a device, system or apparatus that produces some form of output from a given input. A typical example is an engine whose purpose is to produce kinetic energy output from a fuel source.

The present invention can be used in connection with vehicles, such as cars, trucks, buses, tanks, trains, aircraft, helicopters, rockets, boats, submarines and other means of transport. But the invention can also be used in stationary systems or portable systems.

The invention uses a special fuel system which comprises hydrogen peroxide (H₂O₂) plus at least one hydrocarbon. Examples of such hydrocarbons are:

Kerosene (e.g. JP-6 kerosene, or Jet-A or Jet-A1 kerosene)

gasoline

diesel

paraffin oil.

According to the present invention the H₂O₂ plus the hydrocarbon(s) participate in a chemical reaction as will be described later. Best results are obtained if also the additives, e.g. the stabilizing additive, participate in this reaction, which means that the additive has at least two functions. From this point of view alcohol-based additives are very well suited.

When referring to “reaction temperatures”, temperatures between 600° C. and 1100° C., and preferably between 700° C. and 1000° C. are meant. In some applications, the temperatures can even be higher than the ones mentioned.

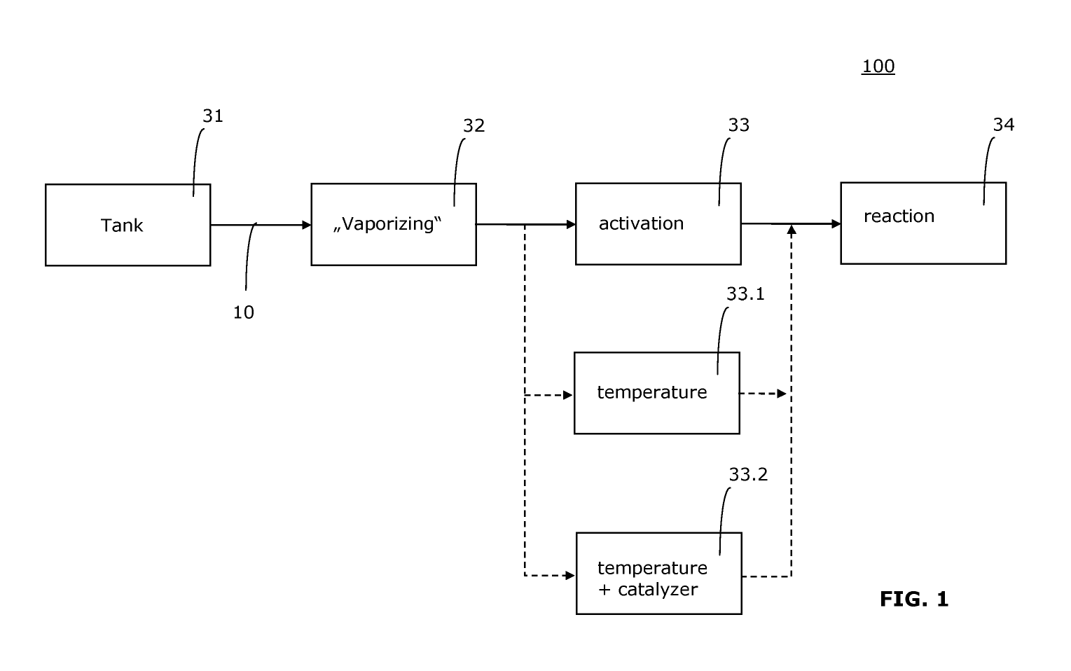

Basic aspects of the invention are described in connection with FIG. 1. This Figure is a schematic block-diagram illustrating functional blocks or elements of an inventive device or system 100.

The inventive fuel system or composition, as described and defined before, is preferably kept in some kind of tank 31 or reservoir. The tank 31 or reservoir may be connectable to a next functional block 32 or element by means of a fuel feed line or pipe 10.

According to the present invention, the fuel system or composition is “vaporized”, which means that the liquid fuel is expanded to a phase with very small droplets or elements are present. The expansion factor is between 5 and 50, preferably between 10 and 30, since in the room or zone into which the liquid fuel is expanded a high pressure is maintained. Without the high pressure, the expansion factor would be much larger. The expression “vaporized” is used as a synonym for the creating or generation of very small particles, droplets or entities out of the liquid fuel system stream. The block 32 represents the respective step, process or system in FIG. 1. In order for a proper reaction in block 31 to take place, the particles, droplets or entities have to be smaller than 100 μm. Preferably, they are as small as 50 μm. In addition, the “vapor” so produced should be homogenous.

After the “vaporization”, the fuel system or composition is activated, as indicated by the block 33. There are two different possibilities for the activation. Both options are illustrated in FIG. 1. The first approach is a thermal activation (block 33.1) where the fuel particles, droplets or entities are heated up to a suitable reaction temperature. The heating up can be done by means of heating elements or by forcing the fuel through a heating section. The heating can be done directly or indirectly.

The second option is a heating approach combined with the employment of a catalyzer (see block 33.2). In this case the activation is ensured by a combination of heat and catalytic action. The catalyzer may be injected or introduced into the fuel, or the fuel particles, droplets or entities may be made to pass by a catalyzer.

Then the reaction takes place (box 34). The word reaction is used in order to emphasize that the fuel does not burn with oxygen like the fuel inside a combustion engine. According to the present invention, a chemical reaction takes place where the atoms or molecules of the fuel particles, droplets or entities are transformed or re-arranged into other molecules. This transformation or rearrangement is done so that the Gibbs free energy is reduced. The Gibbs free energy (Gibbs energy) is a thermodynamic potential which measures the useful or process-initiating work obtainable from the fuel composition or system. According to the invention, the Gibbs free energy is reduced to a minimum since the “products” at the output side of the process (water and carbon dioxide) have a very low thermodynamic potential.

According to the present invention, a chemical reaction takes place where the oxygen of the hydrogen peroxide reacts with carbon from the hydrocarbon(s) to produce CO₂. The hydrogen of the hydrogen peroxide and the hydrogen of the hydrocarbon forms water with the remaining oxygen. No oxygen needs to be provided from external sources and no oxygen is fed into the reaction or activation zone or region.

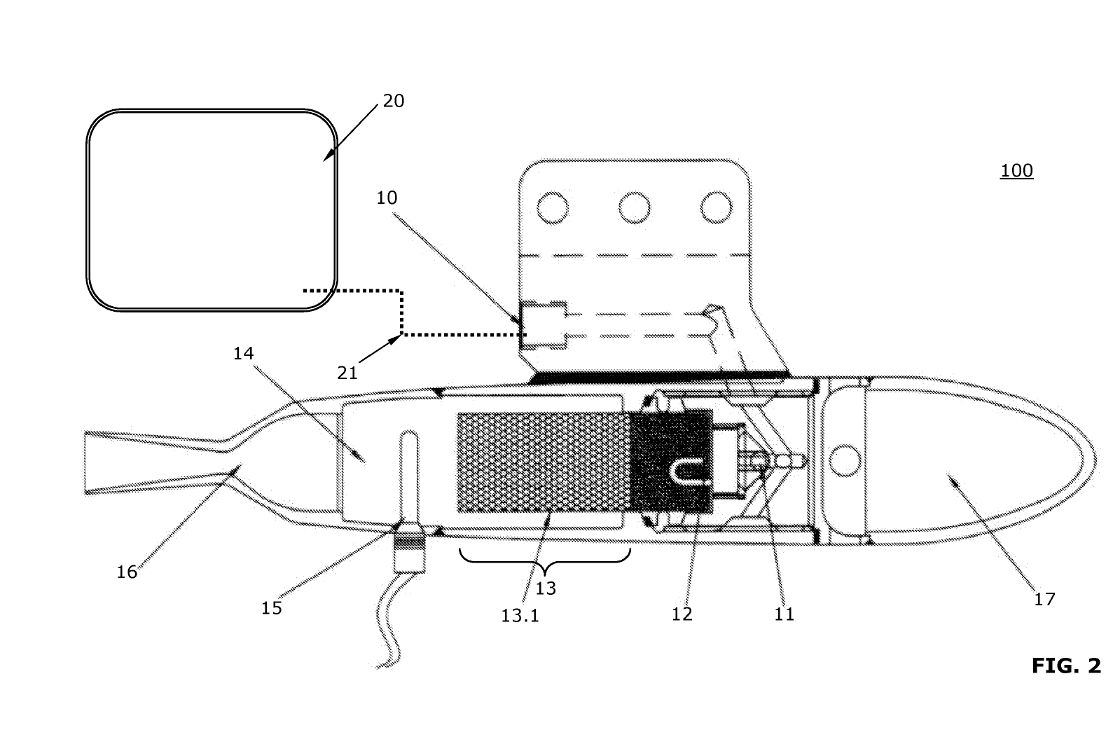

The reaction only takes place in an enclosed environment (called reaction zone or region), since only in such an enclosed environment the right conditions (pressure and temperature) are typically guaranteed. Very well suited is a reaction chamber or tube 14 having an output side with a thrust nozzle 16 (cf. FIG. 2).

The inventive fuel system or composition is designed so that it only reacts if the right conditions are met, which means that the fuel system or composition is very stable and not dangerous in any respect.

Preferably, the temperature in the reaction zone or region is between 700° C. and 1000° C. and the pressure is above 50 bar. Good results are achieved if the pressure is in the range between 60-80 bar. Very well suited is a pressure at about 70 bar.

A first embodiment of the present invention is illustrated in FIG. 2. Details of the invention are now described by making reference to this figure, but it is to be kept in mind that all aspects which are discussed in the context of this specific embodiment can also be used in connection with the other embodiments of the invention.

The novel fuel system presented has the advantage that its autoignition temperature is very high. It is a further advantage of the inventive fuel system that even if an empty fuel tank would contain some residual fuel or an air/fuel mixture, this residual fuel would not react or explode. The residual fuel or combustible air/fuel mixture is stable at ambient temperatures ranging from below −50° C. to above 50° C., at atmospheric pressure. The fuel system does not permit a combustible mixture to develop or exist which would pose a potential hazard.

The fuel system or composition flows through a fuel feed line 10 or infeed into a chamber or zone. When or while entering the chamber or zone, the fuel system or composition is vaporized. The embodiment shown in FIG. 2 comprises a recoil valve 11 followed by a steam creator or generator 12. A (spray) nozzle or injection nozzle may be used as steam creator or generator 12, for instance. Well suited are Piezzo-based steam creators or generators 12. These elements are herein also referred to a vaporizing means which provide for an “atomization” of the fuel. The vaporizing means provide for an expansion of the fuel stream into a fuel cloud or fuel vapor. The factor of expansion is relatively low (between 5 and 50, preferably between 10 and 30), due to the fact that the pressure in the chamber or zone is above 50 bar. Good results are achieved if the pressure is in the range between 60-80 bar. Very well suited is a pressure at about 70 bar.

The recoil valve 11 (or a start up valve) can be employed in order to open or close the fuel streaming into the vaporizing means. A speed or thrust regulator (not shown) may be employed as part of the engine 100 in order to adjust the fuel amount.

The fuel system is typically stored in a tank 20 or container which can be connected to the fuel feed line 10. In FIG. 2 a fuel tank 20 is schematically indicated. It is connectable to the fuel feed line 10, as illustrated by means of a doted line 21. The tank 20 might be a pressurized system, but the fuel system or composition does not require pressurized tanks or the like. The fuel system or composition could also be stored in an open tank.

The tank 20 of the present embodiment, but also the tanks of other embodiments, may be constructed out of carbon-based composite material. But it is also possible to use plastic materials, such as a thermoplastic material, or metal. It is an advantage of the fuel system or composition used, that it cannot be accidentally ignited. The fuel system or composition has the further advantage that it does not burn or explode when being exposed to a flame, for instance. The fuel system or composition is absolutely safe and thus does not jeopardize anybody.

Inside the engine 100 there is an activator 13 which activates the fuel cloud or fuel vapor. The activator 13 comprises a heating element or heating section (not visible in FIG. 2) in order to heat up the fuel. Preferably, a catalyzer 13.1 (e.g. a precious metal activator) is situated at or inside the heating section or near the heating element of the activator 13. The heating section or heating element is designed so that the fuel vapor is quickly heated up to an ignition temperature. The respective temperature range for the reaction temperature is mentioned above. The catalyzer 13.1 may be employed in order to support or assist the ignition process.

As a general rule of thumb one can say that the reaction temperature can be lower if a catalyzer 13.1 is employed. Without such a catalyzer 13.1, the reaction temperature has to be somewhat higher in order to ensure proper initialization of the reaction of the fuel cloud or fuel vapor.

The catalyzer 13.1 provides for a pre-dissociation. Well suited are precious metal activators or activators comprising a catalyst, such as one or more of the following: CoO and/or MgO and/or Platinum and/or Silver and/or Rhodium and/or Palladium.

After the fuel cloud or fuel vapor has passed through the heating section 13 (with or without catalyzer 13.1), the fuel cloud or fuel vapor has reached the reaction temperature and an immediate reaction is guaranteed.

The present embodiment comprises an ignition system 15 with an ignition plug, for instance. The ignition plug may, like in a combustion engine, generate sparks at a suitable rate. But it is also possible to employ an ignition system 15 which is continuously running. Well suited is a glowing metal piece, grid or filament for instance. Preferably, the ignition system 15 is mounted inside a reaction chamber or zone 14 where the fuel reacts. The ignition system 15 can also sit outside (at least partially) the reaction chamber or zone 14, but in this case some portion of the ignition system 15 sits inside or protrudes into the reaction chamber or zone 14.

In a currently preferred embodiment, the reaction chamber or zone 14 is designed so that an enthalpic gas expansion takes place when igniting the fuel cloud or fuel vapor. This means that the gas expands at a total constant enthalpy. This expansion is more or less isotropic.

In a preferred embodiment, the fuel cloud or fuel vapor reaches temperatures of more than 600° C. and a pressure of above 50 bar (good results are achieved if the pressure is in the range between 60-80 bar. Very well suited is a pressure at about 70 bar) inside the reaction chamber or zone 14. This ensures that the fuel expands and dissolves mainly to water (H₂O) vapor and CO₂.

Last but not least there may be a thrust nozzle 16 which is connected on one side to the reaction chamber or zone 14 so that the fuel gas when expanding or reacting is able to expand and exit the engine 10.

Since an inventive and new fuel system or composition is being proposed, special activations means 13 have to be provided which enable the ignition or dissociation of the fuel. As mentioned in connection with the description of FIG. 2, preferably an activator 13 is employed which contains a catalyzer 13.1. The activator 13 comprises at least one heating element or a heating section. In addition, the activator 13 may comprise a net, sieve or stack of layers (herein referred to as catalyzer 13.1) which comprise a catalytic material.

The fuel may be pre-heated before arriving at the activator 13.

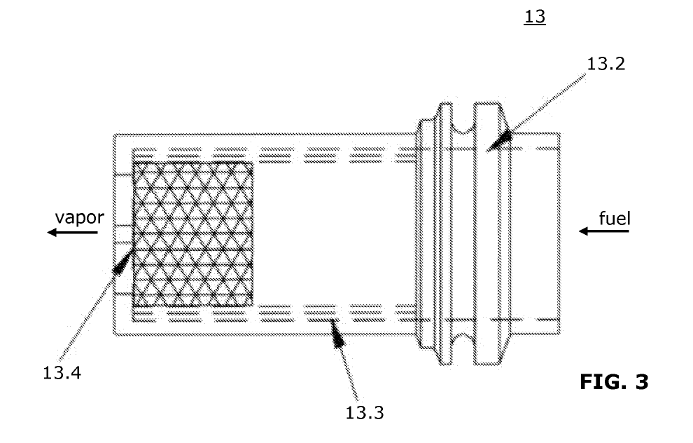

In FIG. 3 a preferred embodiment of an activator 13 is shown. This activator 13 comprises a heatable section (e.g. a heatable pipe) with heating elements 13.3. Furthermore, the activator 13 may comprise a sieve 13.4. This sieve 13.4 provides for the vaporization of the liquid fuel. The sieve 13.4 might at the same time act as a catalyzer. The liquid fuel travels through this activator 13 from the right to the left and is turned into a fuel vapor or cloud. The fuel meets temperatures in excess of 50° C. and preferably about 100° C. to 150° C.

The designs of the embodiments which are shown in FIGS. 2 and 3 are very simple and cost effective and provide for reproducible conditions allowing a reliable ignition of the new fuel system or composition.

It will be understood that many variations could be adopted based on the specific structure hereinbefore described without departing from the scope of the invention as defined in the following claims.

1-25. (canceled)

26. A colloidal fuel composition, comprising 93 to 94.5% by weight of aqueous H₂O₂ having a concentration of 30 to 60% by weight, in particular 30 to 50% by weight, with 7 to 5.5% by weight hydrocarbon, and at least one stabilizing additive.

27. The colloidal fuel composition of claim 26, wherein said stabilizing additive has the following amount: 1.5-15% vol.

28. The colloidal fuel composition of claim 26, wherein the stabilizer additive is selected from alcohols in liquid form at room temperature, in particular from ethanol, propanol, and mixtures thereof.

29. The colloidal fuel composition of claim 26, wherein the stabilizer additive is a surface-active agent having a hydrophobic and a hydrophilic group, preferably a tenside.

30. The colloidal fuel composition of claim 26, wherein said ratio is from 31.3% H₂O₂ and 6.9% hydrocarbon to 46.9% H₂O₂ and 6.3% hydrocarbon.

31. The colloidal fuel composition of claim 26, wherein the hydrocarbon is a hydrocarbon mixture.

32. The colloidal fuel composition of claim 26, wherein the hydrocarbon amount is selected so that the stoichiometric amount of oxygen provided by the H₂O₂ is approximately equal to the stoichiometric amount of carbon provided by the hydrocarbon.

33. The colloidal fuel of claim 26, wherein said fuel comprises at least one additive selected from the group consisting of
anti-knock additives,
anti-oxidant additives,
static dissipater additives,
icing inhibitor additives,
corrosion inhibitor additives,
power boosting additives,
and mixtures of two or more thereof, preferably all.

34. The colloidal fuel of claim 33, wherein the at least one additive, if added, is added in the following amounts:
Anti-knock additives 2-5.7 mg/l
Antioxidant additives 10-15 mg/l
Static dissipater additives 0.6-4.5% vol.
Icing inhibitor additives about 0.10-0.15 mg/l
Corrosion inhibitor additives about 0.05-0.20 mg/l
Power boosting additives 0.02-2.00% vol.

35. The colloidal fuel of claim 30, wherein the hydrocarbon mixture has the following composition:
approx. 10-20% by weight aromatic hydrocarbons,
approx. 0.5-1.5% by weight olefinic hydrocarbons, also known as alkene hydrocarbons,
approx. 80-85% by weight saturated hydrocarbons, i.e. alkanes, also known as paraffinic hydrocarbons, and / or cycloalkanes.

36. The colloidal fuel of claim 34, wherein the aromatic hydrocarbons are primarily selected from benzene derivatives, in particular from the group consisting of toluene, xylene, ethyl benzene, and mixtures of two or more thereof, and/or wherein the olefinic hydrocarbons are primarily selected from C3 to C15 hydrocarbons with 1 to 3 double bonds, in particular from olefinic hydrocarbons or mixtures of olefinic hydrocarbons that are liquid at room temperature, and/or wherein the aliphatic hydrocarbons are selected from linear ad branched C4 to C15 hydrocarbons, and/or from cycloalophatic hydrocarbons, in particular from aliphatic or cycloalipahatic hydrocarbons or mixtures of such hydrocarbons are liquid at room temperature.

37. The colloidal fuel of claim 26, wherein the additives are selected from the following groups: the anti-knock additives selected from propylene alcohol, ketones, aldehydes and mixtures thereof; the antioxidant additives selected from phenols, organic sulphides or polysuiphides, dithiocarbamates, phosphates, phosphonates and mixtures thereof; the static dissipater additives selected from nitroso compounds; the icing inhibitors selected from isopropanol, isopropylen and mixtures thereof; the corrosion inhibitors selected from phenol derivatives in particular from dibutylmethlphenol (BHT), butylhydroxyanisol (BHA), and mixtures thereof; the power boosting additives selected from nitrated aromatics, in particular from trinitrobenzene.

38. A method for producing a colloidal fuel composition having 93 to 94.5% by weight of aqueous H₂O₂, the H₂O₂ in a concentration of 30 to 60% by weight, in particular 30 to 50% by weight, being mixed with 7 to 5.5% by weight hydrocarbon, preferably a hydrocarbon mixture, to give a total of 100% by weight, and wherein a stabilizing additive is added at any time.

39. The method of claim 38 wherein 30-50% by weight concentrated H₂O₂ is mixed with the hydrocarbon in a relation of 93.1% by weight H₂O₂ to 6.9% by weight hydrocarbon, up to 93.7% by weight H₂O₂ to 6.3% by weight hydrocarbon.

40. Use of colloidal fuel composition of claim 26 as a liquid fuel for stationary or mobile engines.

41. The use of claim 40 whereby said colloidal fuel composition undergoes a chemical transformation process where nearly all oxygen is provided by said H₂O₂

42. The use of claim 40 whereby said colloidal fuel composition undergoes a chemical transformation process where the atoms are re-arranged to produce mainly H₂O₂ and CO₂ as output, said transformation providing for a reduction of the Gibbs free energy.

43. The use of claim 40 whereby said stabilizing additive participates in the chemical reaction.

44. Device (100) providing for a chemical reaction of a colloidal composition comprising 93 to 94.5% by weight of aqueous H₂O₂ having a concentration of 30 to 60% by weight, in particular 30 to 50% by weight, with 7 to 5.5% by weight hydrocarbon, and at least one stabilizing additive, said device (100) comprising:
a tank (31) comprising the colloidal fuel composition,
vaporizing means (32)
a feed section (10) for feeding the colloidal fuel composition form the tank (31) to an entry side of the vaporizing means (32),
activation means (13; 33; 33.1; 33.2) having an entry side connected to an exit side of said vaporizing means (32),
reaction means (34) having an entry side connected to an exit side of said activation means (13; 33; 33.1; 33.2), and
an outlet, preferably a nozzle (16) connected to an exit side of the reaction means (34), for releasing mainly water and carbon dioxide; wherein the activation means (13; 33; 33.1; 33.2) at least comprise a heating element or heating section and preferably a catalyzer (13.1).

45. The device of claim 44, wherein the vaporizing means (32) transform the colloidal fuel composition into a fuel vapor or fuel cloud having particles, droplets or entities being smaller than 100 μm.

46. The device of claim 44, wherein the vaporizing means (32) provide for an expansion with an expansion factor between 5 and 50, preferably between 10 and 30.

47. The device of claim 44, wherein the activation means (13; 33; 33.1; 33.2) at least comprise a heating element or heating section, said heating element or heating section being designed so as to raise the temperature of the fuel to more than 50° C., and preferably to a temperature in the range between 100° C. and 150° C.

48. The device of claim 47, wherein the activation means (13; 33; 33.1; 33.2) further comprise a catalyzer (13.1).

49. The device of claim 44, wherein the reaction means (34) comprise a reaction zone or chamber (14) and an ignition system (15) for triggering a reaction which transforms the fuel into the water and carbon dioxide.

50. The device of claim 44, wherein the pressure inside is kept at above 50 bar, preferably in the range between 60-80 bar.
